(19) United States
(12) Patent Application Publication
(10) Pub. No.: US 2014/0156336 A1
(43) Pub. Date: Jun. 5, 2014

(54) SPECIFYING FLEXIBLE BUSINESS PROCESSES USING PRE AND POST CONDITIONS

(71) Applicant: Be Informed B.V., Apeldoom (NL)

(72) Inventors: Jeroen Christiaan Van Grondelle, Hilversum (NL); Gartjan Grijzen, Apeldoorn (NL)

(73) Assignee: Be Informed B.V., Apeldoom (NL)

(21) Appl. No.: 13/895,061

(22) Filed: May 15, 2013

Related U.S. Application Data
(60) Provisional application No. 61/647,957, filed on May 16, 2012.

(51) Int. Cl. G06Q 10/06

(52) U.S. Cl. CPC G06Q 10/06316
USPC 705/7.26

(57) ABSTRACT

A system for supporting a business process, which process is modeled as a set of activities relating to an end goal, each activity having zero or more preconditions and one or more postconditions, the system comprising an inference engine for inferring one or more desired activities whose preconditions are true and which have respective postconditions that must be true in order for the end goal to be reached, an activity execution module for executing each of the activities, a control module for repeatedly (a) causing the inference engine to infer one or more particular desired activities, and (b) causing the activity execution module to execute the particular inferred desired activities, until the end goal has been reached, and a user override module for allowing at any time a user to cause the activity execution module to execute any activity whose preconditions are true, to render one precondition or postcondition true, to declare one precondition or postcondition true and to declare a given precondition inapplicable to a given activity.

### FIELD OF THE INVENTION

The invention relates to a system for supporting a business process, which process is modeled as a set of activities relating to an end goal, each activity having zero or more preconditions and one or more postconditions.

### BACKGROUND OF THE INVENTION

Today's organizations are dealing with a number of trends that increase the complexity of their business. Most governments and enterprises offer products that have many variants and options, depending on the customers' context and his individual choices. Enterprises use this as a marketing tool, increasing their revenue by addressing multiple target groups with specific products. Governments offer products, like grants, taxes and permits, that are the result of complex policies.

Conventional process modeling, in terms of activities and the flow they are executed in has proven to lead to complex and often rigid business processes. The typical IT approach of handing over a specification between disciplines like analysis, functional design and engineering consecutively has become a bottleneck.

Classically, IT has defined business processes in terms of the activities that are performed in an organization and the order in which this is done. Conventional process modeling standards are available, like OMG's Business Process Modeling Notation [1] and the Business Process Execution Language [2]. More recently, the terms Dynamic Case Management [3] and Adaptive Case Management [4] were coined for more dynamic, rule oriented approaches, that address the fact that the complexity we described earlier has proven to pose a challenge when using the metaphor of forks to accommodate process variants or exceptions. The number of processes created often match the large number of product variations, even when these process variants essentially perform the same task.

Using declarative techniques in process modeling is broadly seen as a way to overcome limitations of conventional, imperative approaches, both in industry and academics. In for instance [5], Goedertier and Vanthienen describe the differences between declarative and imperative process modeling and how a declarative approach helps to model the actual business concerns instead of, with an imperative approach, model a process flow that meets these constraints implicitly. In [6], Pesic and Van der Aalst introduce a ConDec language that attempts to reduce over-specification and introduce aspects of flexibility by using declarative techniques to specify business processes. In [7], Schonenberg et al. describe different aspects of flexibility required in today's business processes. Also in this paper, replacing flow by declarative (precedence) constraints is presented as a source of flexibility. Andersson et al. address flexibility, traceability and business orientation in [8] by introducing an activity dependency model that focuses on the type of dependencies that exist between activities.

There is a need for an improved modeling process for business processes that focuses on modeling the different concerns noted above, without requiring manual consolidation of all the requirements into a business process that is believed to address all of them. The needed process should be flexible with respect to changing circumstances.

### SUMMARY OF THE INVENTION

The invention improves on the above by providing a system for supporting a business process, which process is modeled as a set of activities relating to an end goal, each activity having zero or more preconditions and one or more postconditions, more particularly as claimed in claim 1.

In the system of the invention, the order of activities is not defined in advance and hence not rigid. The control module at each repetition step causes one or more activities to be selected based on the postconditions that these activities may render true, and on the preconditions of these activities that may or may not be true. Collectively, the values of these conditions and the outcomes of activities is referred to as the world state (but note that this does not imply the world state must be explicitly recorded or tracked as such).

A business process or business method is a collection of related, structured activities or tasks that produce a specific service or product (serve a particular goal) for a particular customer or customers. Describing business processes with pre- and post-conditions allows business modeling professionals to focus on the constraints that have to be met by a business process, instead of describing a consolidated flow of which the analysts creating it believe the process will stay within constraints at all time. Using the constraints, inferring a process is left to the inference engine, which infers individual flows for each process instance. The override mechanism allows the user, based on expertise and context, to choose the best activity within the specified constraints.

Based on the desired end goal of the process (the goal), the current world state and the context, the process engine infers an activity that can and must be performed to reach that end goal. If the current state is changed by user override, the process engine in the next step just re-infers what is needed given the new situation. There is no need to model explicit exception flows for exceptions or overrides that are to be expected. This has the benefit that there are no unexpected situations either.

The override allows a user to ‘break into’ the state to execute an arbitrary activity or to avoid activities. This does not require modification to (or even interaction with) the inference engine, execution modules or the process definition, as the next time an activity is selected given the world state, the result of the action performed by the user has simply become part of the world state. Executing an activity could e.g. be initiated by providing a button to start the activity. The user has various ways to render a condition true: e.g. uploading a document, adding or changing an item in a database, or checking a box in a user interface. To declare a condition true, false or inapplicable requires nothing more than the pressing of an appropriate button or selection of an appropriate checkbox.

Various approaches to business process support are known that employ backwards chaining and pre- and postcondition evaluation [9, 10, 11]. None of these approaches disclose the control module as claimed or the override module as claimed.

US 2004/0162741 discloses a method and apparatus for product lifecycle management in a distributed environment enabled by dynamic business process composition and execution by rule inference. A distributed network topology connects a hierarchy of functional domains, each domain having a service ontology and one or more service composition schemas defined by the service ontology. Each service composition schema models a business process in its domain. A business flow manager uses backward-chain inferencing and then forward-chain inferencing to generate the ad-hoc workflows, based on user identification of a target task. The business flow manager is able to stop execution of the workflow and regenerate a workflow for remaining tasks in response to events received over the network from service providers, and is also able to detect conflicts in the workflows at composition time and at execution time. This apparatus does not allow for arbitrary selection of an activity to be performed, it is stuck in a workflow approach. Moreover it does not allow manual override at any time.

In an embodiment the inference engine is configured for inferring plural desired activities that all have postconditions that must be true in order for the end goal to be reachable and the control module is configured for causing the activity execution module to execute one or more of the plural inferred desired activities. This embodiment has the advantage that time is saved spending on inferring which preconditions have been met in between certain activities. If it is known in advance that two activities are needed and possible, there is generally no need to re-infer activities in between. However, in a refinement the inference engine may be configured to compare the postconditions of the plural activities and eliminate from the plurality those activities with overlapping postconditions, thus avoiding the execution of activities that potentially may be redundant.

In a further refinement of this embodiment the activity execution module comprises an activity selection module for presenting the plural inferred desired activities to the user, for receiving a selection of one or more of the plural inferred desired activities and for causing the activity execution module to execute the selected one or more of the plural inferred desired activities. By letting the user select one or more activities, a quick way to obtain the selection is achieved. In addition, this refinement provides the user with a feeling of being in control.

In a yet further refinement of this embodiment the activity execution module comprises an activity selection module for determining for each of the plural inferred desired activities if user interaction is needed, and for making a selection of an activity that requires no user interaction if at least one such activity is part of the plural inferred desired activities. This refinement gives preference non-interactive activities, such as calculations or data processing on already-existing data. It is well known that in most business support systems, 90% of the time is spent waiting for users. Hence, with this refinement the system will often operate faster. Further, user time interacting with the system is saved as the non-interactive activities may result in postconditions that make interactive activities unnecessary later on.

In a yet further refinement of this embodiment each activity has an associated preference indicator and the activity execution module comprises an activity selection module for selecting one of the plural inferred desired activities that has the relatively highest preference indicator. This refinement allows an easy definition up-front of the preferred order of activities in case multiple activities are needed and possible. Optionally, the user may be allowed to adjust the preference indicators of various activities at any time, as yet another way of manually influencing the system.

In a yet further refinement of this embodiment an activity selection module for selecting a subset of the plural activities, which subset consists of activities requiring user interaction, and for causing the activity execution module to execute the activities of the subset together. By executing plural activities that all require user interaction together, the user is presented with all these required activities at once, allowing him to do all the work in one session. This is generally more efficient than having multiple interactions throughout the day.

In a further embodiment the user override module is configured for, in case the inference engine infers that no desired activity exists whose preconditions are true, forcing the user to declare or render one precondition or postcondition true or to declare one precondition inapplicable to a given activity. If the end goal is unreachable, user intervention is necessary.

In a further embodiment preconditions and/or postconditions have associated temporal validity information, and the inference engine is configured to infer the plural desired activities further based on the temporal validity and a current time. Temporal validity information may comprise starting and/or ending dates or times for the validity of the information. Temporal validity information may also relate to the condition itself For example, a change in law at a certain date in the future may render a particular precondition irrelevant from that date on. Conversely, a postcondition may become invalid at some point in time because it is “too old”, e.g. when a copy of a driver's license must be no older than three months. In that case the postcondition “copy of driver's license is present” has been met upon the provision of that copy, but three months later the postcondition becomes false as the copy no longer satisfies the temporal validity requirement.

In a further embodiment the system further comprises a state manager for managing a global state of the business process in terms of preconditions and postconditions that are true, the control module being configured for causing the state manager to update the global state based on the one or more postconditions of the executed inferred desired activity, after the activity execution module has executed the particular inferred desired activity, and the user override module being configured for allowing at any time the user to declare or render one precondition or postcondition as true in the global state and to declare one precondition inapplicable to a given activity within the global state. As discussed above the world state is an important aspect of the invention. By explicitly managing a global state of the business process in terms of preconditions and postconditions that are true, a very efficient way of verifying preconditions and postconditions becomes possible.

The invention further provides for a computer-readable storage medium comprising executable code for causing a computer to operate as the system of the invention.

### BRIEF DESCRIPTION OF THE FIGURES

The invention will now be explained in more detail with reference to the figures, in which:

FIG. 1 schematically shows a high-level overview of the system of the invention and the various modules it comprises;

FIG. 2 shows a flowchart illustrating the workings of the control module;

FIG. 3 schematically illustrates an interface to the system allowing a user to declare a precondition or postcondition as true in the global state.

In the figures, same reference numbers indicate same or similar features. In cases where plural identical features, objects or items are shown, reference numerals are provided only for a representative sample so as to not affect clarity of the figures.

### DETAILED DESCRIPTION OF CERTAIN EMBODIMENTS

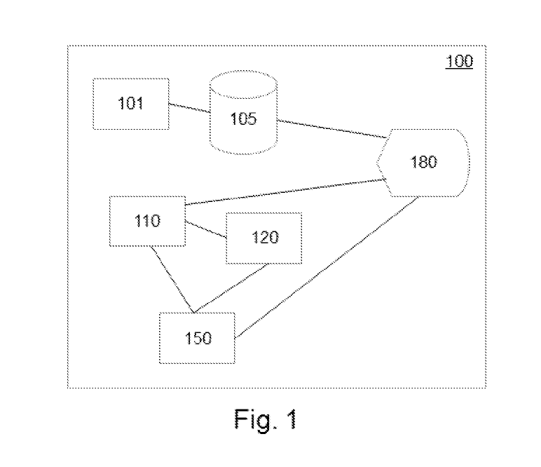

FIG. 1 schematically shows a high-level overview of the system 100 of the invention and the various modules it comprises. Various advantageous embodiments and variations thereof will be discussed, without limiting the generality of the invention.

In the embodiment shown, the system 100 comprises a state manager 101 which is configured for managing a global state of the business process in terms of preconditions and postconditions that are true. To store the global state, the state manager 101 has access to a database 105, e.g. an internal or external hard disk or a network-connected storage.

Other ways of managing the global state are also possible. Each activity within the business process might for instance have a corresponding data object in which relevant parts of the state information is recorded. Alternatively each activity may have an associated data object that records the validity of its preconditions, and upon completion of an activity all data objects are identified that have a precondition that is satisfied now that the completed activity has completed. These preconditions can then be declared as true.

In another embodiment no precondition or postcondition validity as such is recorded. Instead, when an activity is selected, its preconditions are evaluated on the fly. For example if a precondition is that a certain document must be present, the presence of the document is checked. The results of the evaluation could be cached.

An inference engine 110 is provided for inferring one or more desired activities whose preconditions are true and which have a postcondition that must be true in order for the end goal to be reached. This will be discussed below in more detail.

An activity execution module 120 is provided for executing the activities. Executing an activity by itself is a well-known concept to the skilled person and will not be discussed in detail. The earlier references, in particular [9, 10, 11] should provide a good starting point.

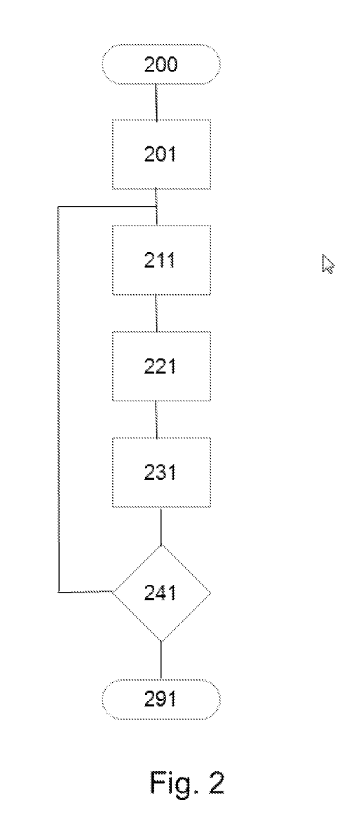

A control module 150 is provided for repeatedly, until the end goal has been reached, (a) causing the inference engine 110 to infer a particular desired activity and (b) causing the activity execution module 120 to execute the particular inferred desired activity. In case a state manager 101 is employed, the control module 150 further is provided for (c) causing the state manager 101 to update the global state based on the one or more postconditions of the executed inferred desired activity. The workings of the control module 150 are illustrates below with reference to the flowchart of FIG. 2.

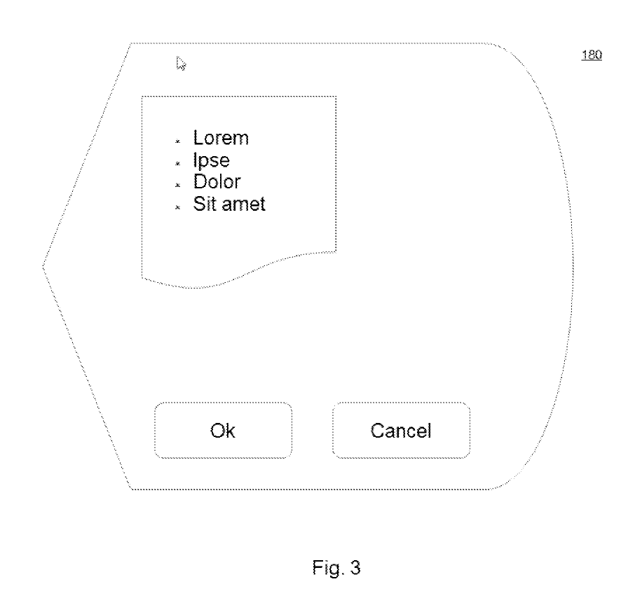

A user override module 180 is provided for allowing at any time a user to cause the activity execution module 120 to execute any activity whose preconditions are true, to render or declare one precondition or postcondition true, and to declare a given precondition inapplicable to a given activity. In an embodiment, the module 180 is configured for, in case the inference engine 110 infers that no desired activity exists whose preconditions are true, forcing the user to render or declare one precondition or postcondition true or to declare one precondition inapplicable to a given activity. The user interface is illustrated in FIG. 3.

FIG. 2 shows a flowchart illustrating the workings of the control module 150. The flowchart starts at 200 and proceeds to step 201, where the control module 150 takes the end goal of the business process and then in step 211 causes the inference engine 110 to infer a first particular desired activity that relates to the end goal. When the inference engine 110 has done so, then in step 221 control module 150 activates the activity execution module 120 so as to cause it to execute the particular inferred desired activity.

Upon execution the control module 150 in step 231 causes the state manager 101 to update the global state based on the one or more postconditions of the executed inferred desired activity. Next, in step 241 the control engine 150 determines if the end goal has been reached. If so, the method completes at step 291. If not, the method returns to step 211 where the control engine 150 causes the inference engine 110 to infer a next particular desired activity that relates to the end goal. Thus, the process steps repeat until the end goal has been reached.

The business process in the invention is modeled as a collection of activities, each having zero or more preconditions and one or more postconditions. Examples of activities are requesting a permit, performing an assessment of a situation, and a decision to grant a benefit.

For example, consider a business process for deciding whether to grant a building permit to a citizen. In this process various activities must be undertaken to reach the end goal, that is the various postconditions of the business process. For example, the citizen must hand in a diagram of the intended building activities, and a check with a zoning database must be done to verify that the building takes place on ground owned by the citizen. And of course the identity of the citizen must be verified with a copy of an identification document.

The invention could model this process by introducing a first activity to receive the diagram of the intended building activities, a second activity to receive the copy of the identification document and a third activity to verify ownership of the ground on which the building is to take place. Each of these activities has one postcondition, and all three postconditions must be true to achieve the end goal of the business process. However, this end goal itself must also be modeled: hence a fourth activity is introduced that checks the information provided and either produces a building permit or a rejection letter. This fourth activity has three preconditions, which are satisfied by the three postconditions mentioned earlier. The fourth activity has three postconditions: the decision to grant or reject itself, the issuance of the permit (if granted) and the issuance of the rejection (if not). The latter two postconditions are conditional upon the first.

The inference engine will initially infer that the fourth activity is desired, because the decision to grant is an end goal of the business process. However, the inference engine will soon discover that this fourth activity has three preconditions which must be satisfied before the fourth activity can be undertaken.

The inference engine will now identify one of the four activities, say the first activity (receive diagram). This activity has no preconditions so it can be executed. As part of the activity, the diagrams themselves are uploaded to the system, which renders the postcondition true that the diagrams have been so uploaded.

The inference engine will next select the second or the third activity for execution. Assume the third activity is now chosen, normally now the verification with the zoning office has to be made. However, the user now performs an override by rendering the postcondition true that the verification has been made. This override can be executed in many ways, for example by providing a dialog screen with an upload interface, allowing the user to manually upload a document providing the verification information. In this approach, the override thus avoids the normal process flow in which the verification information would only have been asked at a later time.

Alternatively the override can be executed by simply declaring that the verification has been made. While this is not desirable as it effectively allows the user to circumvent a process step, there may be situations where this declaration is useful or desired. Yet alternatively the user now performs an override to declare the precondition inapplicable to the third activity.

To clarify, the difference between ‘rendering true’ and ‘declaring true’ in essence is that a declaration simply defines something to be the case, whether or not this is actually true, and a rendering causes the something in question to actually occur. Declaring that a driver's license has been uploaded is just that: a statement. Rendering the same would require the uploading of a document that represents a driver's license.

Of course uploading of a driver's license could also occur naturally in the normal process flow, but it may be desirable to break into the process and upload the license at an earlier time. This is where rendering true is useful. Declaring true is useful when the actual activity cannot be performed for some reason (e.g. the license has been lost by its owner) yet the process must continue (the owner must be registered as a renter of a rental car and this requires a valid driver's license).

In both cases, the result becomes part of the global state of the business process. The alternative of ‘declaring inapplicable’ does not affect the global state. It merely ensures that the activity can proceed whether or not the precondition is true. This by definition is a step specific to that particular activity.

The user could also employ an override by causing the activity execution module to execute any activity whose preconditions are true. In this embodiment the user could choose the third activity (identification) first.

The inference engine 110 is designed to infer one or more desired activities in the abovementioned business process whose preconditions are true and which have respective postconditions that must be met in order for the end goal to be reached. By itself, evaluating pre- and/or postconditions is well known and will not be elaborated upon further.

In an embodiment, the preconditions and/or postconditions evaluated by the inference engine 110 have associated temporal validity information. A precondition or postcondition may be applicable only before or after a certain point in time, and be ignored after or before that point. The value of a precondition or postcondition may also be valid only before or after a certain point in time, and be invalid after or before that point. If such temporal validity information is present (which may or may not be the case and which may be used for certain but not all conditions), then the inference engine 110 should take this into account, by using the time at which inference takes place. Alternatively or in addition, if the state manager 101 is employed, the state manager 101 may periodically evaluate the temporal validity information. Upon such evaluation the state manager 101 can update the global state as appropriate, e.g. by removing no longer valid state information or declaring a particular condition to be always true or false.

While the inference engine 110 may be configured to infer only one activity at a time, which activity is then executed and a new inference is made, it may be desirable to infers plural desired activities at one time that all have postconditions that must be true in order for the end goal to be reachable. In this case, the control engine 150 should be configured for causing the activity execution module 120 to execute one or more of the plural inferred desired activities. Various embodiments may be thought of to handle this situation.

In one embodiment the activity execution module 120 simply executes all the inferred activities in sequence and/or in parallel, depending on the characteristics of the activities.

In another embodiment a selection of a subset of the plural desired activities can be made, and then only the subset is executed. To this end, the activity execution module 120 comprises an activity selection module 125. This module 125 is responsible for selecting the activity or activities to be executed. In a first variation of this embodiment, the module 125 is coupled to an interface for presenting the plural inferred desired activities to the user. Upon receipt of a user a selection of the subset, the activity execution module 120 is signaled to execute this subset.

In a second variation, the activity selection module 125 determines for each of the plural inferred desired activities if user interaction is needed, and selects only a subset with plural activities if those activities require no user interaction. In this variation, the approach is that plural non-interactive activities can be executed at once (in parallel and/or in sequence) but interactive activities should be done one at a time. This has the advantage that if one interactive activity renders another interactive activity moot, the other interactive activity is not executed.

In a third variation, the activity selection module 125 determines for each of the plural inferred desired activities if user interaction is needed, and selects a subset consists of activities that do require user interaction. These activities are then executed together by the activity execution module 120. Each such activity will have an associated user interface element (e.g. a definition of an input to be requested, or a form to be filled in). Such elements are now presented together, allowing the user to provide all the needed user interaction in one session. The elements may be presented in a single screen and/or in a series of screens, e.g. in the well-known wizard format.

In a fourth variation, each activity has an associated preference indicator, indicating in which order of preference activities are to be executed. A simple implementation would use a scale of 1 (lowest) to 100 (highest) and simply select one of the plural inferred desired activities that has the relatively highest preference indicator. The indicator can be set by the user in advance, or be inferred from various environmental factors. For example, if execution time of an activity is known in advance, the indicator can be derived from this factor—either by preferring the shortest time (i.e. preferring quickly-executing activities to ensure a fast interaction with the system) or by preferring the longest time (i.e. preferring long processing activities to avoid bothering the user). Of course “highest” is relative: if the interpretation of the scale is reversed, then so is the interpretation of “highest”.

### CLOSING NOTES

The above provides a description of several useful embodiments that serve to illustrate and describe the invention. The description is not intended to be an exhaustive description of all possible ways in which the invention can be implemented or used. The skilled person will be able to think of many modifications and variations that still rely on the essential features of the invention as presented in the claims. In addition, well-known methods, procedures, components, and circuits have not been described in detail.

Some or all aspects of the invention may be implemented in a computer program product, i.e. a collection of computer program instructions stored on a computer readable storage device for execution by a computer. The instructions of the present invention may be in any interpretable or executable code mechanism, including but not limited to scripts, interpretable programs, dynamic link libraries (DLLs) or Java classes. The instructions can be provided as complete executable programs, as modifications to existing programs or extensions (“plugins”) for existing programs. Moreover, parts of the processing of the present invention may be distributed over multiple computers or processors for better performance, reliability, and/or cost.

Storage devices suitable for storing computer program instructions include all forms of non-volatile memory, including by way of example semiconductor memory devices, such as EPROM, EEPROM, and flash memory devices, magnetic disks such as the internal and external hard disk drives and removable disks, magneto-optical disks and CD-ROM disks. The computer program product can be distributed on such a storage device, or may be offered for download through HTTP, FTP or similar mechanism using a server connected to a network such as the Internet. Transmission of the computer program product by e-mail is of course also possible.

When constructing or interpreting the claims, any mention of reference signs shall not be regarded as a limitation of the claimed feature to the referenced feature or embodiment. The use of the word “comprising” in the claims does not exclude the presence of other features than claimed in a system, product or method implementing the invention. Any reference to a claim feature in the singular shall not exclude the presence of a plurality of this feature. The word “means” in a claim can refer to a single means or to plural means for providing the indicated function.

### REFERENCES

1. Business Process Modeling Notation 2.0, http://www.omg.org/spec/BPMN/2.0/(Online)
2. Business Process Execution Language 2.0 http://docs.oasis-open.org/wsbpel/2.0/OS/wsbpel-v2.0-OS.html (Online)
3. Le Clair, C., Moore, C., Dynamic Case Management—An Old Catches New Fire, Forrester Research, 2009.
4. Swenson, K. D., Mastering the Unpredictable: How Adaptive Case Management Will Revolutionize the Way That Knowledge Workers Get Things Done, Meghan-Kiffer Press, 2010.
5. S. Goedertier and J. Vanthienen: Declarative process modeling with business vocabulary and business rules. In R. Meersman, Z. Tari, and P. Herrero, editors, On the Move to Meaningful Internet Systems 2007: OTM 2007 Workshops, LNCS volume 4805, pages 603-612. Springer, 2007.
6. M. Pesic and W. van der Aalst. A declarative approach for flexible business processes management. In J. Eder and S. Dustdar, editors, Business Process Management Workshops, LNCS volume 4103, pages 169-180, Springer, 2006.
7. H. Schonenberg, R. Mans, N. Russell, N. Mulyar, and W. Aalst. Process flexibility: A survey of contemporary approaches. In W. Aalst, J. Mylopoulos, M. Rosemann, et al., editors, Advances in Enterprise Engineering I, LNCS volume 10, pages 16-30. Springer, 2008.
8. B. Andersson, M. Bergholtz, A. Edirisuriya, T. Ilayperuma, and P. Johannesson. A declarative foundation of process models. In 0. Pastor and J. Falcão e Cunha, editors, Advanced Information Systems Engineering, LNCS volume 3520, pages 339-377. Springer, 2005.
9. Ingo Weber. Semantic Methods for Execution-level Business Process Modeling. PhD thesis, Universität Karlsruhe (TH), November 2009. Springer, Lecture Notes in Business Information Processing (LNBIP) Vol. 40, ISBN 978-3-642-05084-8.
10. Jan Schaffner and Harald Meyer. Mixed Initiative Use Cases for Semi-Automated Service Composition: A Survey. IW-SOSE '06, May 27-28, 2006, Shanghai, China.
11. Patrick Albert, Laurent Henocque and Mathias Kleiner. Configuration Based Workflow Composition. IEEE International Conference on Web Services, 2005.

1. A system for supporting a business process, which process is modeled as a set of activities relating to an end goal, each activity having zero or more preconditions and one or more postconditions, the system comprising:
an inference engine for inferring one or more desired activities whose preconditions are true and which have respective postconditions that must be true in order for the end goal to be reached,
an activity execution module for executing each of the activities,
a control module for repeatedly (a) causing the inference engine to infer one or more particular desired activities, and (b) causing the activity execution module to execute the particular inferred desired activities, until the end goal has been reached, and
a user override module for allowing at any time a user to cause the activity execution module to execute any activity whose preconditions are true, to render one precondition or postcondition true, to declare one precondition or postcondition true and to declare a given precondition inapplicable to a given activity.

2. The system of claim 1, in which the inference engine is configured for inferring plural desired activities that all have postconditions that must be true in order for the end goal to be reachable and the control module is configured for causing the activity execution module to execute one or more of the plural inferred desired activities.

3. The system of claim 2, in which the activity execution module comprises an activity selection module for presenting the plural inferred desired activities to the user, for receiving a selection of one or more of the plural inferred desired activities and for causing the activity execution module to execute the selected one or more of the plural inferred desired activities.

4. The system of claim 2, in which the activity execution module comprises an activity selection module for determining for each of the plural inferred desired activities if user interaction is needed, and for making a selection of an activity that requires no user interaction if at least one such activity is part of the plural inferred desired activities.

5. The system of claim 2, in which each activity has an associated preference indicator and the activity execution module comprises an activity selection module for selecting one of the plural inferred desired activities that has the relatively highest preference indicator.

6. The system of claim 2, comprising an activity selection module for selecting a subset of the plural activities, which subset consists of activities requiring user interaction, and for causing the activity execution module to execute the activities of the subset together.

7. The system of claim 1, in which the user override module is configured for, in case the inference engine infers that no desired activity exists whose preconditions are true, forcing the user to render or declare one precondition or postcondition true or to declare one precondition inapplicable to a given activity.

8. The system of claim 1, in which preconditions and/or postconditions have associated temporal validity information, and the inference engine is configured to infer the plural desired activities further based on the temporal validity and a current time.

9. The system of claim 1, further comprising a state manager for managing a global state of the business process in terms of preconditions and postconditions that are true, the control module being configured for causing the state manager to update the global state based on the one or more postconditions of the executed inferred desired activity, after the activity execution module has executed the particular inferred desired activity, and the user override module being configured for allowing at any time the user to declare one precondition or postcondition as true in the global state, to render one precondition or postcondition as true in the global state and to declare one precondition inapplicable to a given activity within the global state.

10. A computer-readable storage medium comprising executable code for causing a computer to operate as the system of claim 1.
